(19) United States
(12) Patent Application Publication
(10) Pub. No.: US 2003/0023553 A1
(43) Pub. Date: Jan. 30, 2003

(54) Remote self-servicing management of invoicing for billing parties

(75) Inventor: Roger W. Applewhite, Palos Verdes Estates, CA (US)

Correspondence Address: Gary B. Solomon, Esq., Jenkens & Gilchrist, P.C., Suite 3200, 1445 Ross Avenue, Dallas, TX, 75202, US

(73) Assignee: PEROT SYSTEMS CORPORATION

(21) Appl. No.: 10/252,156

(22) Filed: Sep. 19, 2002

Related U.S. Application Data
(63) Continuation of application No. 09/495,016, filed on Jan. 31, 2000.

(51) Int. Cl. G06F 17/60

(52) U.S. Cl. 705/40

(57) ABSTRACT

A method and apparatus for generating a machine-readable invoice is recited. In one embodiment, a method for generating such a machine-readable invoice includes the steps of establishing an invoicing party account including an invoicing party identifier and a financial institution identifier; receiving an invoiced party identifier, the invoiced party identifier associated with an invoiced party; receiving an amount due for the invoice; forming an indication of a computer-readable indicia, the indication of the computer-readable indicia incorporating the invoicing party identifier, the financial institution identifier, the invoiced party identifier, and the amount due for the invoice; and printing the computer-readable indicia corresponding to the indication of the computer-readable indicia on the invoice.

### BACKGROUND OF THE INVENTION

1. Field of the Invention

The present invention relates to data management systems and in particular, but not by way of limitation, to systems and methods for managing data to thereby create computer-readable invoices.

2. Background of the Problem and Related Art

For many individuals such as those without checking accounts, paying bills is often a cumbersome process. Because it is typically not recommended to send cash through the mail, these individuals usually pay their household bills by delivering cash to some sort of stand-alone collection facility. Often these collection facilities are inconveniently located for the billed party, and moreover, these collection facilities result in significantly increased collection costs for the billing/invoicing party. Accordingly, a method and apparatus are needed for allowing individuals to conveniently and securely pay bills with any type of tender—including cash.

Additionally, it has been recognized that invoicing parties often incur great expense in processing payments sent through the mail. For example, invoicing parties must maintain sizable staffs and facilities to collect, sort and manage incoming payments. Furthermore, invoicing parties lose potential revenue in that they do not have access to the payment funds until they are actually received at the processing facility. That is, the invoicing parties lose the ability to use the payment funds for the three or so days that the payments are in the mail. Accordingly, a method and apparatus are needed that reduce the expense in processing payments and that allow invoicing parties quicker access to payment funds. The present invention addresses these and other problems in an innovative system and method.

### SUMMARY OF THE INVENTION

To remedy the deficiencies of existing systems and methods, the present invention provides a method and apparatus for data management and the subsequent creation of computer-readable invoices that can allow for more efficient and convenient bill/invoice processing.

In one embodiment, for example, the present invention includes the steps of establishing an invoicing party account including an invoicing party identifier and a financial institution identifier, the invoicing party identifier being associated with the invoice and the financial institution identifier being associated with the invoicing party; receiving an invoiced party identifier, the invoiced party identifier associated with an invoiced party; receiving an amount due for the invoice; forming an indication of a computer-readable indicia, the indication of the computer-readable indicia incorporating the invoicing party identifier, the financial institution identifier, the invoiced party identifier, and the amount due for the invoice; and printing the computer-readable indicia corresponding to the indication of the computer-readable indicia on the invoice.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1a illustrates a point-of-sale system constructed according to the principles of the present invention;

FIG. 1b illustrates a point-of-sale system incorporated into a retail establishment;

FIG. 2 illustrates a bar-coded bill usable by the point-of-sale system of FIG. 1; and

FIG. 3 illustrates a bar-coded invoice management system constructed according to the principles of the present invention.

### DETAILED DESCRIPTION

Although the present invention is open to various modifications and alternative constructions, a preferred exemplary embodiment that is shown in the drawings is described herein in detail. It is to be understood, however, that there is no intention to limit the invention to the particular forms disclosed. One skilled in the art can recognize that there are numerous modifications, equivalences and alternative constructions that fall within the spirit and scope of the invention as expressed in the claims.

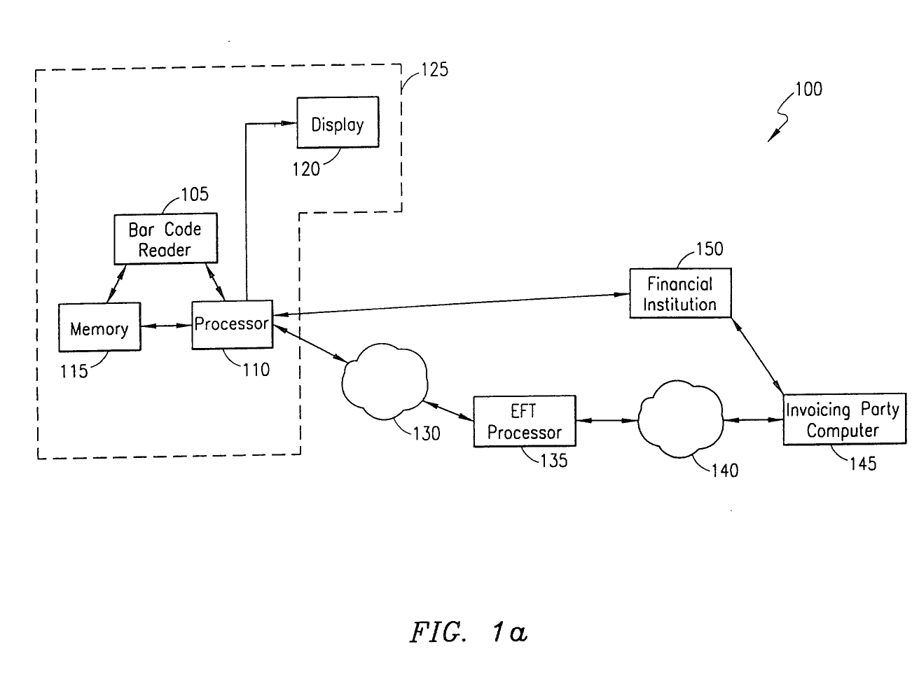

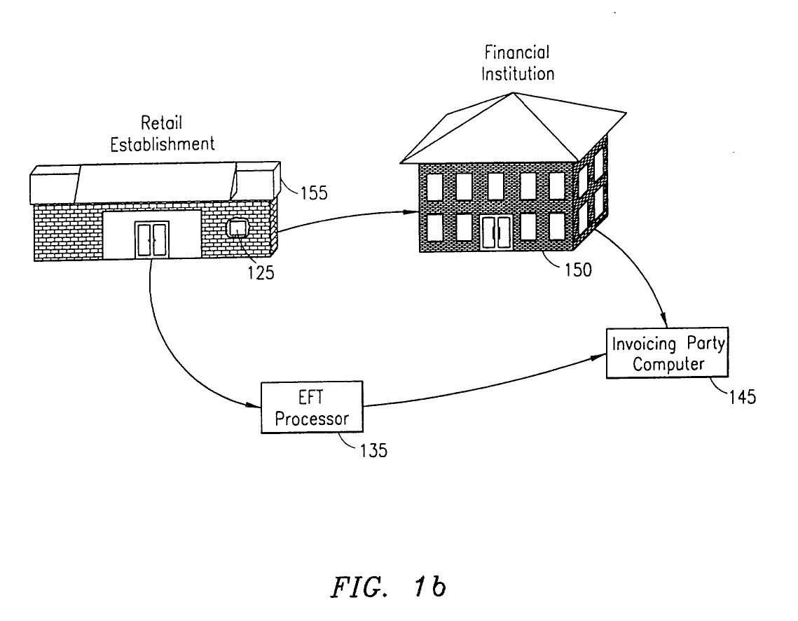

Referring now to FIGS. 1a and 1b, there is illustrated a point-of-sale system 100 constructed according to the principles of the present invention and a point-of-sale system 100 incorporated into a retail establishment 155. In one embodiment, portions of the point-of-sale system 100 are incorporated into a merchant's existing bar-code-reading hardware. For example, the point-of-sale system 100 could be incorporated into a retail establishment's 155 (e.g. a grocery store's) existing bar code reader system. Thus, a customer could buy groceries and pay bills at the same time. A customer would merely present the bill to the cashier as he would any other consumer item, e.g., grocery item.

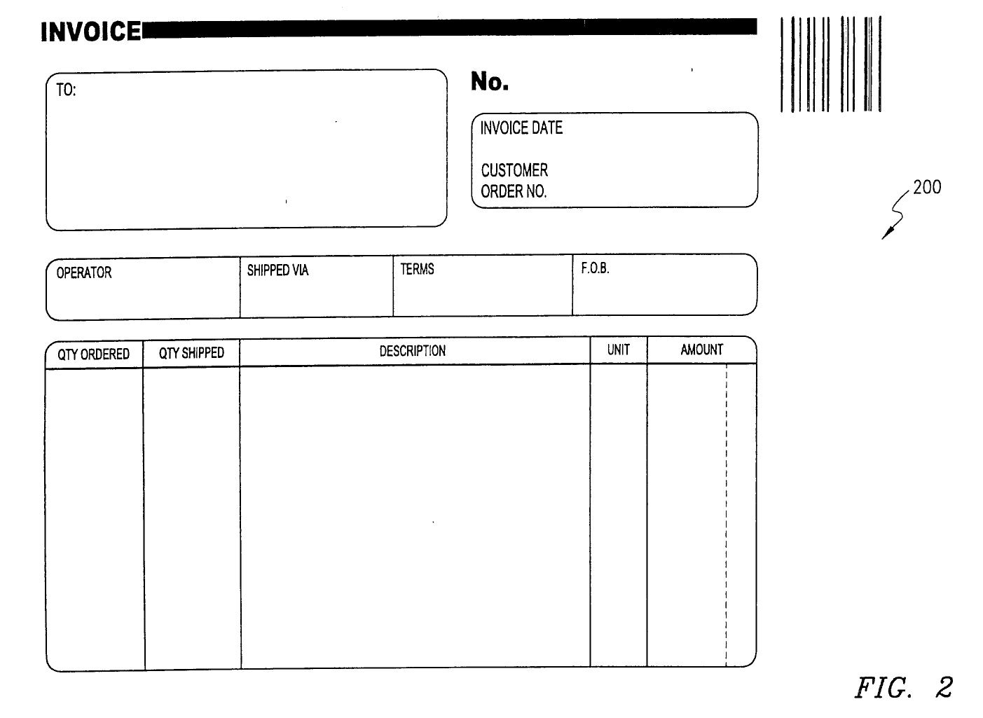

In operation, a bill/invoice with a computer-readable indicia, such as the bar-coded bill 200 illustrated in FIG. 2, is read by the bar code reader 105, which is driven by the processor 110 and software stored on the memory device 115. (Together, the bar code reader 105, the processor 110, the memory device 115, and the display 120 form the bar code system 125.) The bar code system 125 separates the information contained in the bar code on the bar-coded bill into data items such as invoiced-party information, invoicing party information, account information, routing number, invoice number, amount due, etc. The invoiced party paying the bill can be given the option to pay the entire amount due on the bill or to pay only a portion thereof. If the individual chooses to pay only a portion of the total amount of the bill, then that partial amount should be keyed into the bar code system 125.

Once all items—including, for example, grocery items—have been entered into the bar code system 125, the total amount due is calculated and can be displayed on the display 120. The total amount due reflects not only the amount of the bar-coded bill 200 but also the amount of the other items purchased. The invoiced party can then pay the total amount due by any means accepted by the merchant—including cash, debit or credit card, check, etc. Additionally, the bar code system 125 can generate a transaction record that includes, among other things, the invoicing party information, the amount paid, the date, and a tracking number that can be used to verify payment.

After the customer has paid the total amount due, the bar code system 125 transfers information relating to the bar-coded bill 200 through the network 130 to an electronic funds transfer (EFT) processor 135. This transferred information can include an invoicing party identifier, an invoiced party identifier, any information read from the bar code on the bar-coded bill 200, a time stamp, the amount actually paid on the invoice and other useful information. If required, this information can be assembled to form a standard electronic fund transaction record. moreover, in one embodiment, the transferred information can be encrypted for security reasons.

Because the EFT processor 135 can receive numerous records daily that relate to the bar-coded bill 200, the EFT collects all bill payment information for that day (or some other time period) and forms a batch that can be transmitted in bulk through the network 140 to the invoicing party computer 145 or to some intermediary (not illustrated in FIG. 1) that is responsible for handling the invoicing party's financial matters. If the information is transmitted to the intermediary, the intermediary would then be responsible for organizing the received information and presenting it to the invoicing party in an agreed upon format.

Furthermore, the merchant's financial institution 150 is informed of the collections performed on behalf of the invoicing party. The financial institution can be informed directly by the merchant—such as by the bar code system 125, or alternatively, the financial institution can be informed by the intermediary (not illustrated) or the EFT processor 135. Once informed that the merchant collected a bar-coded bill for the billing party, the financial institution 150 forwards the appropriate funds to the invoicing party in accordance with accepted banking practices.

In one embodiment, the merchant retains a copy of at least some of the information relating to the bar-coded bill 200. The merchant can use this retained information to update customer loyalty accounts. For example, the merchant could give the invoiced party some type of credit for future grocery purchases, make certain specials available to the invoiced party, etc. Furthermore, if the invoiced party is paying by check, that party's customer loyalty account can be electronically examined to determine whether the check should be accepted, rejected or reviewed by a supervisor.

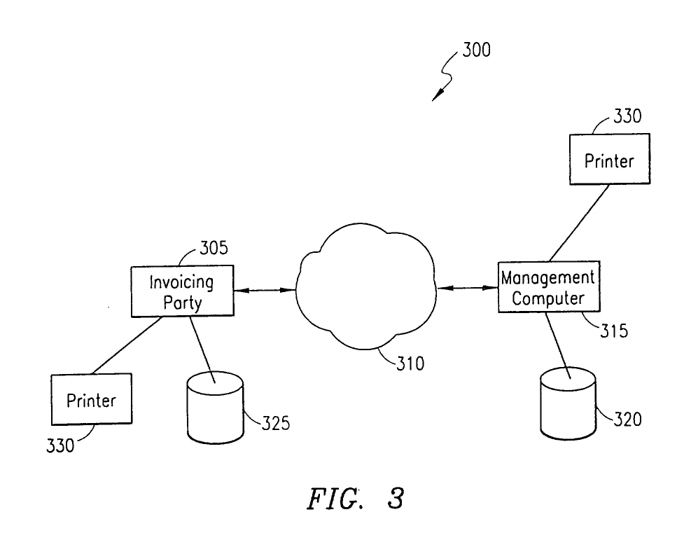

Referring now to FIG. 3, there is illustrated an invoice management system 300 constructed according to the principles of the present invention. The invoice management system 300 includes an invoicing party computer 305 (which can correspond to the invoicing party computer 145 shown in FIG. 1) connected through a network 310, such as the Internet, to a management computer 315. In one embodiment, the invoice management system 300 can be used by the invoicing party to create bar-coded bills such as the one shown in FIG. 2.

To create bar-coded bills or otherwise manage an account, the invoicing party (through the invoicing party computer 305) should initially establish an account with the management computer 315. To establish such an account, the invoicing party should provide the management computer 315 with bank account information, business address, tax identifiers, etc. Next, the invoicing party should provide the management computer 315 with invoiced party information such as customer address, customer account number, amount owed, itemizations, or any other information to appear on the invoiced party's invoice. This information can be stored directly at the storage device 320 (associated with the management computer 315) for retrieval at a later time, or the information can be stored at the storage device 325 (associated with the invoicing party computer 305) and transmitted to the management computer 315 as needed. Alternatively, portions of the information may be distributed between each of the management computer 315 and the invoicing party computer 305.

Regardless of which computer the data is stored at, in one embodiment, the management computer 315 has access to all necessary information—either through its own storage device 320 or through the billing party's storage device 325. The management computer can use this information to generate the special bar-coded bills 200. These bar-coded bills 200 can be printed at a printer 330 associated with the management computer 315 or they can be directly e-mailed to the appropriate customers. When the bills are e-mailed, the customers (invoiced party) would be responsible for printing out the bills if necessary. The bill, if printed, could include the special bar code so that the bill could be processed by the point-of-sale system 100 illustrated in FIG. 1. Additionally, the email-received bill could be printed and paid by regular mail or merely paid through an on-line transaction.

In another embodiment, the management computer 315 would transmit the bar code information back to the invoicing party computer 305. The invoicing party computer 305 could then associate the bar code information with the individual customers and print out bar-coded bills at the associated printer 330. The invoicing party then would be responsible for distributing the bills.

In yet another embodiment, the software responsible for generating the bar-coded bills is available directly at the invoicing party computer 305. Thus, the invoicing party computer 305 could generate the bar-coded bills without accessing the management computer 315. In one variation of this embodiment, the invoicing party computer 305 would transfer certain information about any generated bar-coded bills to the management computer 315. The management computer 315 could use this information for collection purposes, statistical purposes, account management purposes, etc.

Still referring to FIG. 3, the management computer 315 also can provide account management features. That is, the management computer 315 can act as the intermediary referred to with relation to FIG. 1. For example, the management computer 315 can receive batch information from the EFT processor 135 (shown in FIG. 1) or any other appropriate source. The management computer 315 would then be responsible for processing the received information and providing any reports to the billing party. For example, the management computer 315 could transfer billing reports to the billing party computer 305 through the network 310.

Moreover, the management computer 315 could be responsible for arranging the transfer of money from the merchant's financial institution either to itself for later distribution to the merchant or to the merchant directly. Also, the management computer 315 can calculate service fees based upon the number of bar-coded bills processed or the total amount collected through the point-of-sale system 100 (shown in FIG. 1).

In conclusion, the various embodiments of the present invention provide a system and apparatus for total bill management. For example, the system allows bar-coded bills to be created and distributed. Furthermore, the system allows for the bar-coded bills to be payed and processed by a convenient point-of-sale system. Accordingly, the present invention can make bill payment easier for those without checking accounts, and it also can make bill collection less costly for the billing party. Therefore, the present invention results in a net gain for consumers in that the consumer will benefit from passed on cost-savings and convenience.

Those skilled in the art, however, can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for generating a computer-readable invoice, the method comprising the steps of:
receiving invoicing party information;
receiving invoiced party information;
receiving invoice detail information;
concatenating the provided invoicing party information, the provided invoiced party information and the provided invoice detail information to form a representation of a computer-readable indicia, the computer-readable indicia corresponding to the received invoicing party information, the received invoiced party information and the received invoice detail information; and
transferring the representation of the computer-readable indicia for inclusion on the machine-readable invoice.

2. The method of claim 1, wherein the step of transferring the representation of the computer-readable indicia includes the step of electronically transferring the representation of the computer-readable indicia to a remote computer system.

3. The method of claim 1, further comprising the step of printing the computer readable indicia on the machine-readable invoice.

4. The method of claim 1, wherein the step of forming a computer-readable indicia includes the step forming a bar code.

5. The method of claim 1, wherein the invoicing party information includes fund routing information and an invoicing party identifier.

6. The method of claim 1, wherein the invoice detail information includes an amount due on the invoice.

7. The method of claim 1, wherein the invoice detail information includes a due date for the invoice.

8. A method for generating an invoice, the method comprising the steps of:
establishing an invoicing party account including an invoicing party identifier and a financial institution identifier, the invoicing party identifier being associated with the invoice and the financial institution identifier being associated with the invoicing party;
receiving an invoiced party identifier, the invoiced party identifier associated with an invoiced party;
receiving an amount due for the invoice;
forming an indication of a computer-readable indicia, the indication of the computer-readable indicia incorporating the invoicing party identifier, the financial institution identifier, the invoiced party identifier, and the amount due for the invoice; and
printing the computer-readable indicia corresponding to the indication of the computer-readable indicia on the invoice.

9. The method of claim 8, further comprising the step of:
transmitting the indication of the computer-readable indicia to a remote computer;
wherein the step of printing is performed responsive to receiving the computer-readable indicia at the remote computer.

10. The method of claim 8, wherein the step of printing includes the step of printing a bar code.

11. The method of claim 10, wherein the step of receiving the invoiced party identifier includes the step of receiving the invoiced party identifier from a remote computer.

12. The method of claim 11, wherein the step of receiving the amount due for the invoice includes the step of receiving the amount due from a remote computer.

13. A computer system for generating an invoice, the computer system comprising:
a processor;
a storage device connected to the processor, the storage device for storing a plurality of instructions readable by the processor to thereby cause the processor to:
establish an invoicing party account including an invoicing party identifier and a financial institution identifier, the invoicing party identifier being associated with the invoice and the financial institution identifier being associated with the invoicing party;
receive an invoiced party identifier, the invoiced party identifier associated with an invoiced party;
receive an amount due for the invoice;
form an indication of a computer-readable indicia, the indication of the computer-readable indicia incorporating the invoicing party identifier, the financial institution identifier, the invoiced party identifier, and the amount due for the invoice; and
print the computer-readable indicia corresponding to the indication of the computer-readable indicia on the invoice.

14. The system of claim 13, wherein the instructions are further configured to cause the processor to:
transmit the indication of the computer-readable indicia to a remote computer;
wherein the step of printing is performed responsive to receiving the computer-readable indicia at the remote computer.

15. The system of claim 13, wherein the computer-readable indicia includes a bar code.

16. The system of claim 13, wherein the instructions are further configured to cause the processor to:
receive the invoiced party identifier from a remote computer.

17. The system of claim 13, wherein the instructions are further configured to cause the processor to:
receive the amount due for the invoice from a remote computer.

18. The system of claim 13, wherein the instructions are further configured to cause the processor to:
print the computer-readable indicia corresponding to the indication of the computer-readable indicia on the invoice, wherein the computer-readable indicia is a single computer-readable indicia.

19. The system of claim 13, wherein the instructions are further configured to cause the processor to:
print the computer-readable indicia corresponding to the indication of the computer-readable indicia on the invoice, wherein the computer-readable indicia includes a first computer-readable indicia and a second computer-readable indicia, the second computer-readable indicia being separate from the first computer-readable indicia.
